(19) United States
(12) Patent Application Publication
(10) Pub. No.: US 2026/0188996 A1
(43) Pub. Date: Jul. 2, 2026

(54) ELECTRONIC FUSE CIRCUIT AND FUSE CIRCUITRY

(71) Applicant: PowerX Semiconductor Corporation, Hsinchu County (TW)

(72) Inventor: Shih-Ming CHEN, Hsinchu County (TW)

(21) Appl. No.: 19/243,741

(22) Filed: Jun. 20, 2025

(30) Foreign Application Priority Data
Dec. 30, 2024 (TW) 113151561

(51) Int. Cl. H02H 3/08; H02H 1/00; H02H 5/04

(52) U.S. Cl. CPC H02H 3/08; H02H 1/0007; H02H 5/047

(57) ABSTRACT

An electronic fuse circuit includes a fuse switch and a current control circuit. The fuse switch is coupled to the current control circuit at a main control node. The current control circuit includes a switch, a switch control circuit and a control enabling circuit. The switch is coupled to the main control node, the switch control circuit and the control enabling circuit. The switch generates a sinking current to adjust a voltage level of the main control node downward. The switch control circuit controls the switch according to an output current of the fuse switch, an average current voltage and a temperature dependent voltage. The control enabling circuit enables the switch control circuit to control the switch when at least one of preset conditions is satisfied. The preset conditions include the output current exceeding a current threshold and a junction temperature of the fuse switch exceeding a temperature threshold.

### CROSS-REFERENCE TO RELATED APPLICATION

This application claims priority to Taiwan Application Serial Number 113151561, filed on Dec. 30, 2024, which is herein incorporated by reference in its entirety.

### BACKGROUND

### Field of Invention

This disclosure relates to an electronic fuse circuit and a fuse circuitry, in particular to an electronic fuse circuit and a fuse circuitry which adopt self-adaptive control.

### Description of Related Art

In related arts, before the practical use of the existing circuitry composed of multiple electronic fuses connected in parallel, the user usually requires considering the heat dissipation ability of each electronic fuse and the distribution of heat sources around each electronic fuse, and manually applies individual settings to the exterior resistor(s) and/or capacitor(s) of each electronic fuse, to ensure that the power switch element(s) in each electronic fuse can be operated in the safe operating area. However, such approach causes the increase in complexity of producing materials, thereby increasing the time schedule and the cost of research and development.

In addition, as long as some situations, such as a sudden change in the temperature condition, occur in the practical use of the existing circuitry, the individual setting for each electronic fuse may not respond to the changed temperature condition, which may result in that the power switch element(s) in part or all of the electronic fuses cannot be operated in the safe operating area.

### SUMMARY

An aspect of present disclosure relates to an electronic fuse circuit. The electronic fuse circuit includes a fuse switch and a current control circuit. The fuse switch is coupled to a main control node, is configured to generate an output current and an output voltage according to an input voltage, and is configured to adjust the output current and the output voltage according to a voltage level of the main control node. The current control circuit is coupled to the main control node, and includes a first switch, a first switch control circuit and a control enable circuit. The first switch is coupled to the main control node and a first sub control node, is configured to generate a first sinking current, and is configured to adjust the first sinking current according to a voltage level of the first sub control node, wherein the first sinking current flows out of the main control node, and is configured to adjust the voltage level of the main control node downward. The first switch control circuit is coupled to the first sub control node, and is configured to adjust the voltage level of the first sub control node according to the output current, an average current voltage and a temperature dependent voltage, wherein the average current voltage is related to an average of the output current of the electronic fuse circuit and at least another output current of at least another electronic fuse circuit. The control enable circuit is coupled to the first sub control node, and is configured to, when the output voltage exceeds a starting voltage level, enable the first switch control circuit to adjust the voltage level of the first sub control node in response to at least one of a plurality of preset conditions being satisfied, wherein the plurality of preset conditions include the output current exceeding a current threshold and a junction temperature of the fuse switch exceeding a temperature threshold, and the temperature dependent voltage is related to the junction temperature of the fuse switch.

Another aspect of present disclosure relates to a fuse circuitry. The fuse circuitry includes a first electronic fuse circuit and a second electronic fuse circuit. The first electronic fuse circuit has a first input pin, a first output pin and a first temperature monitoring pin. The second electronic fuse circuit is connected in parallel to the first electronic fuse circuit, and has a second input pin, a second output pin and a second temperature monitoring pin. The first input pin and the second input pin are coupled at a first node together, the first output pin and the second output pin are coupled at a second node together, and each of the first electronic fuse circuit and the second electronic fuse circuit includes a fuse switch and a current control circuit. The fuse switch is coupled to a main control node, is configured to receive an input voltage from the first node, is configured to generate an output current according to the input voltage, is configured to generate an output voltage at the second node according to the input voltage, and is configured to adjust the output current and the output voltage according to a voltage level of the main control node. The current control circuit is coupled to the main control node, and includes a first switch, a first switch control circuit and a control enable circuit. The first switch is coupled to the main control node and a first sub control node, is configured to generate a first sinking current, and is configured to adjust the first sinking current according to a voltage level of the first sub control node, wherein the first sinking current flows out of the main control node, and is configured to adjust the voltage level of the main control node downward. The first switch control circuit is coupled to the first sub control node, and is configured to adjust the voltage level of the first sub control node according to the output current, an average current voltage and a temperature dependent voltage, wherein the average current voltage is related to an average of the output current of the first electronic fuse circuit and the output current of the second electronic fuse circuit. The control enable circuit is coupled to the first sub control node, and is configured to, when the output voltage exceeds a starting voltage level, enable the first switch control circuit to adjust the voltage level of the first sub control node in response to at least one of a plurality of preset conditions being satisfied, wherein the plurality of preset conditions include the output current exceeding a current threshold and a junction temperature of the fuse switch exceeding a temperature threshold, and the temperature dependent voltage is related to the junction temperature of the fuse switch.

### BRIEF DESCRIPTION OF THE DRAWINGS

The present disclosure can be more fully understood by reading the following detailed description of the embodiment, with reference made to the accompanying drawings as follows:

FIG. 1 is a block diagram of an electronic fuse circuit in accordance with some embodiments of the present disclosure;

FIG. 2 is a circuit block diagram of a fuse circuitry in accordance with some embodiments of the present disclosure;

FIG. 3 is a circuit block diagram of a fuse circuitry in accordance with some embodiments of the present disclosure;

FIG. 4 is a relation curve diagram of an output current and a junction temperature of a fuse switch in accordance with some embodiments of the present disclosure;

FIG. 5 is a circuit schematic diagram of a soft start circuit in accordance with some embodiments of the present disclosure;

FIG. 6 is a signal timing diagram of an input voltage, an output voltage and an indication signal in accordance with some embodiments of the present disclosure;

FIG. 7 is a circuit schematic diagram of a current-limiting circuit in accordance with some embodiments of the present disclosure;

FIG. 8 is a circuit schematic diagram of a current control circuit in accordance with some embodiments of the present disclosure;

FIG. 9 is a circuit schematic diagram of a current detection circuit in accordance with some embodiments of the present disclosure; and

FIG. 10 is a circuit schematic diagram of a temperature reporting circuit in accordance with some embodiments of the present disclosure.

### DETAILED DESCRIPTION

The embodiments are described in detail below with reference to the appended drawings to better understand the aspects of the present application. However, the provided embodiments are not intended to limit the scope of the disclosure, and the description of the structural operation is not intended to limit the order in which they are performed. Any device that has been recombined by components and produces an equivalent function is within the scope covered by the disclosure.

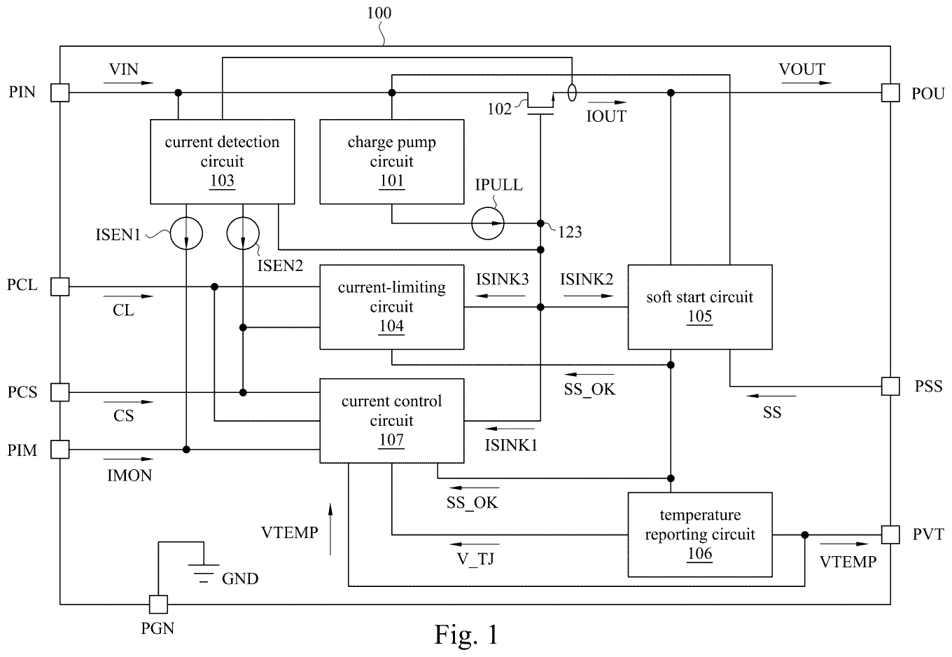

Referring to FIG. 1, FIG. 1 is a block diagram of an electronic fuse circuit 100 in accordance with some embodiments of the present disclosure. In some embodiments, the electronic fuse circuit 100 can be coupled between a power supply (not shown) and a load device (not shown), to provide the load device with a variety of protections (such as an over current protection, an over voltage protection, an over temperature protection, etc.) when the power supply supplies power for the load device.

In some embodiments, the electronic fuse circuit 100 is configured to receive an input voltage VIN through an input pin PIN and output an output current IOUT and an output voltage VOUT through an output pin POU. It should be understood that the input voltage VIN can be provided by the power supply, and the electronic fuse circuit 100 can supply the power for the load device by using the output current IOUT and the output voltage VOUT.

In some embodiments, the electronic fuse circuit 100 is configured to detect whether at least one of some preset conditions is satisfied and further to adjust a current level of the output current IOUT downward when at least one of the preset conditions is satisfied, thereby achieving the variety of protections. For example, the preset conditions include the output current IOUT exceeding a current threshold IT1 or at least one current limit value (not shown). In another example, the preset conditions include a junction temperature of a fuse switch 102 in the electronic fuse circuit 100 exceeding a temperature threshold. Notably, by detecting whether at least one of the preset conditions is satisfied to adjust the current level of the output current IOUT downward, the electronic fuse circuit 100 has advantages of self-adaptive control, improving power transmission efficiency, etc. The relevant embodiments will be further described later, and the circuit structure of the electronic fuse circuit 100 is described in detail below. As used herein, “adjusting a voltage or current level downward” can refer to an adjustment slowing a rise of a voltage or current level down or an adjustment leading to a fall of a voltage or current level.

In some embodiments, as shown in FIG. 1, in addition to the fuse switch 102, the electronic fuse circuit 100 further includes a charge pump circuit 101, a current detection circuit 103, a current-limiting circuit 104, a soft start circuit 105, a temperature reporting circuit 106 and a current control circuit 107.

In some embodiments, the fuse switch 102 can be implemented by a transistor (e.g., N-type metal oxide semiconductor transistor), but the present disclosure is not limited thereto. As shown in FIG. 1, a first terminal (e.g., a drain terminal) of the fuse switch 102 is coupled to the input pin PIN, a second terminal (e.g., a source terminal) thereof is coupled to the output pin POU, and a control terminal (e.g., a gate terminal) thereof is coupled to a main control node 123. The fuse switch 102 can generate the output current IOUT and the output voltage VOUT according to the input voltage VIN and adjust the output current IOUT and the output voltage VOUT according to a voltage level of the main control node 123 (i.e., the voltage level of the control terminal of the fuse switch 102). For example, when the voltage level of the main control node 123 is gradually increased from a disable voltage level (i.e., the voltage level allowing the fuse switch 102 to be turned off), the fuse switch 102 may be switched from a turn-off state into a partial turn-on state and then into a complete turn-on state, so as to increase the output current IOUT and the output voltage VOUT correspondingly.

The charge pump circuit 101 is coupled to the input pin PIN and the main control node 123, and is configured to generate a pull-up current IPULL flowing to the main control node 123. In particular, the pull-up current IPULL is configured to adjust the voltage level of the main control node 123 upward. As used herein, “adjusting a voltage or current level upward” can refer to an adjustment leading to a rise of a voltage or current level or an adjustment slowing a fall of a voltage or current level down. It should be understood that if the voltage level of the main control node 123 is adjusted to the highest voltage level achievable by the electronic fuse circuit 100 by the pull-up current IPULL, the fuse switch 102 would be in the complete turn-on state, that is, the fuse switch 102 can have the lowest turn-on impedance and the lowest transmission loss.

The current detection circuit 103 is coupled to the input pin PIN, the output pin POU, a current monitoring pin PIM and a current sensing pin PCS of the electronic fuse circuit 100 and the main control node 123, and configured to detect the output current IOUT to output a sensing current ISEN1 and another sensing current ISEN2 to the current monitoring pin PIM and the current sensing pin PCS, respectively. In particular, both the sensing current ISEN1 and the sensing current ISEN2 are in a preset ratio with the output current IOUT. For example, both of a current level of the sensing current ISEN1 and a current level of the sensing current ISEN2 are 1/M times a current level of the output current IOUT, where M can be a positive integer greater than 0. When M is 1, the output current IOUT, the sensing current ISEN1 and the sensing current ISEN2 are substantially the same.

The current control circuit 107 is coupled to the main control node 123, the soft start circuit 105, the temperature reporting circuit 106, the current monitoring pin PIM and the current sensing pin PCS and further to a current-limiting pin PCL and a temperature monitoring pin PVT of the electronic fuse circuit 100. The current control circuit 107 is configured to detect whether the output current IOUT exceeds the current threshold IT1 and whether the junction temperature of the fuse switch 102 exceeds the temperature threshold after the soft start circuit 105 indicates that a soft start operation of the electronic fuse circuit 100 is finished. When the output current IOUT exceeds the current threshold IT1 and/or the junction temperature of the fuse switch 102 exceeds the temperature threshold, the current control circuit 107 generates a sinking current ISINK1 flowing out of the main control node 123 to adjust the voltage level of the main control node 123 downward, so as to control the output current IOUT to approach a target current level.

The soft start circuit 105 is coupled to the main control node 123, the input pin PIN, the output pin POU, a soft start pin PSS of the electronic fuse circuit 100, the current-limiting circuit 104, the current control circuit 107 and the temperature reporting circuit 106. The soft start circuit 105 is configured to generate a sinking current ISINK2 flowing out of the main control node 123 to adjust the voltage level of the main control node 123 downward and further control a rising slope of the output voltage VOUT according to a soft start voltage SS during an execution duration of the soft start operation. The soft start circuit 105 is further configured to indicate whether the soft start operation of the electronic fuse circuit 100 is finished by an indication signal SS_OK, that is, the indication signal SS_OK indicates a state of the soft start operation of the electronic fuse circuit 100.

The current-limiting circuit 104 is coupled to the main control node 123, the current sensing pin PCS, the current-limiting pin PCL and the soft start circuit 105. The current-limiting circuit 104 is configured to detect whether the output current IOUT exceeds at least one current limit value. When the output current IOUT exceeds at least one current limit value, the current-limiting circuit 104 is configured to generate a sinking current ISINK3 flowing out of the main control node 123 to adjust the voltage level of the main control node 123 downward, so that the output current IOUT does not exceed at least one current limit value.

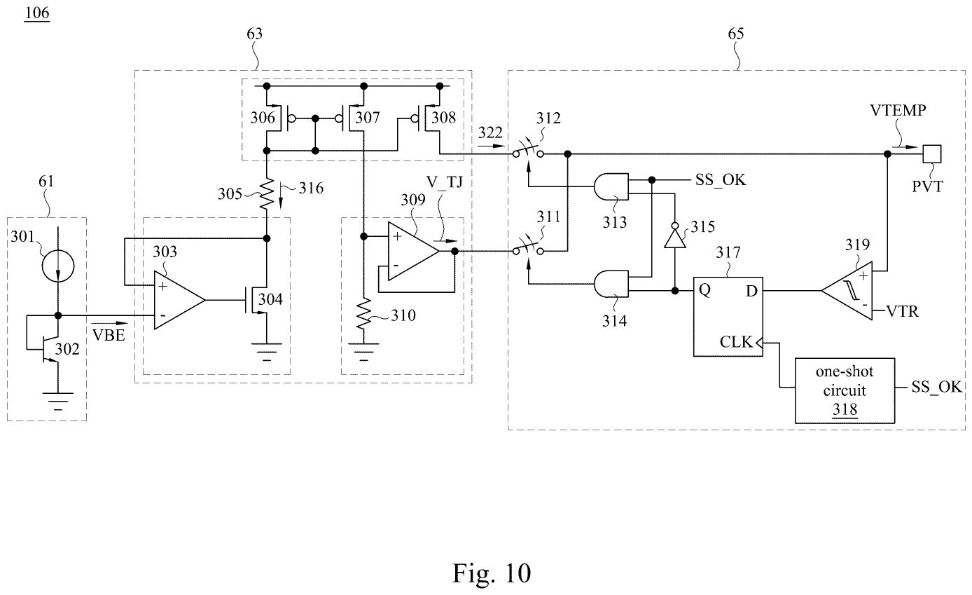

The temperature reporting circuit 106 is disposed near the fuse switch 102, and coupled to the soft start circuit 105, the current control circuit 107 and the temperature monitoring pin PVT. The temperature reporting circuit 106 is configured to detect the junction temperature of the fuse switch 102 and generate a temperature dependent voltage V_TJ and a temperature dependent current 322 (which is not shown in FIG. 1 but in FIG. 10) according to the junction temperature of the fuse switch 102. The temperature reporting circuit 106 is further configured to determines an external connection pattern (which would be described later) of the temperature monitoring pin PVT during the execution duration of the soft start operation. The temperature reporting circuit 106 is also configured to provide one of the temperature dependent voltage V_TJ and the temperature dependent current 322 to the temperature monitoring pin PVT after the soft start circuit 105 indicates that the soft start operation of the electronic fuse circuit 100 is finished, so as to generate a temperature monitoring voltage VTEMP at the temperature monitoring pin PVT.

In addition, as shown in FIG. 1, the electronic fuse circuit 100 further includes a ground pin PGN, and the ground pin PGN is configured to provide a ground voltage GND for each circuit in the electronic fuse circuit 100.

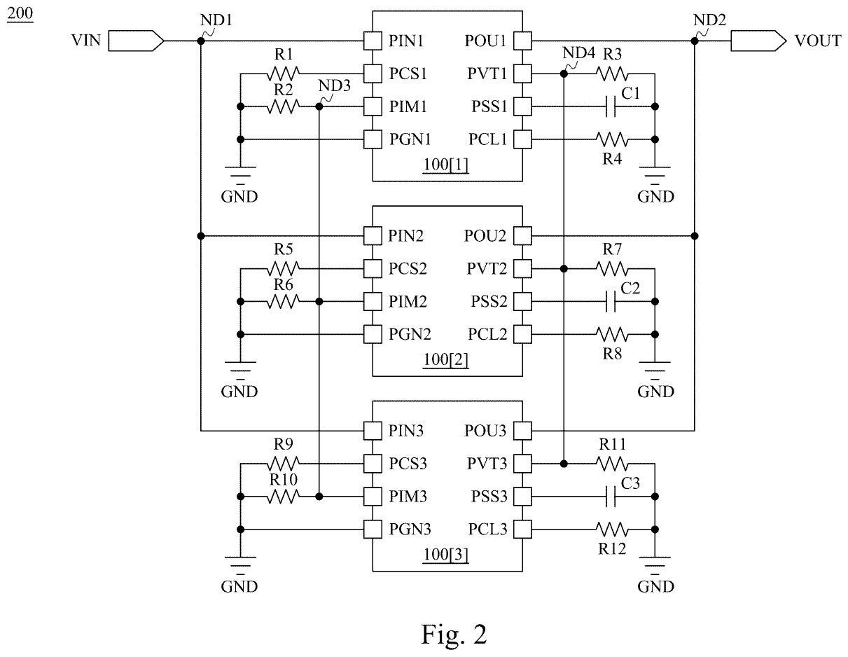

Referring to FIG. 2, FIG. 2 is a circuit block diagram of a fuse circuitry 200 in accordance with some embodiments of the present disclosure. In some embodiments, the fuse circuitry 200 is composed of multiple electronic fuse circuits 100[1]-100[3] connected in parallel. It should be understood that each of the electronic fuse circuits 100[1]-100[3] in FIG. 2 can be implemented by the electronic fuse circuit 100 of FIG. 1.

As shown in FIG. 2, the respective input pins PIN1-PIN3 of the electronic fuse circuits 100[1]-100[3] are commonly coupled to a node ND1, to receive the input voltage VIN through the node ND1. The respective output pins POU1-POU3 of the electronic fuse circuits 100[1]-100[3] are commonly coupled to a node ND2, to generate the output voltage VOUT at the node ND2. The respective output currents IOUT of the electronic fuse circuits 100[1]-100[3] converge at the node ND2 to generate a total output current of the fuse circuitry 200. Moreover, the respective ground pins PGN 1-PGN3 of the electronic fuse circuits 100[1]-100[3] are coupled to the ground voltage GND.

The current sensing pin PCS1 of the electronic fuse circuit 100[1] is coupled to the ground voltage GND through a resistor R1. The current sensing pin PCS2 of the electronic fuse circuit 100[2] is coupled to the ground voltage GND through a resistor R5. The current sensing pin PCS3 of the electronic fuse circuit 100[3] is coupled to the ground voltage GND through a resistor R9. The respective current monitoring pins PIM1-PIM3 of the electronic fuse circuits 100[1]-100[3] are commonly coupled to a node ND3. The current monitoring pin PIM1 is coupled to the ground voltage GND through a resistor R2. The current monitoring pin PIM2 is coupled to the ground voltage GND through a resistor R6. The current monitoring pin PIM3 is coupled to the ground voltage GND through a resistor R10.

The respective temperature monitoring pins PVT1-PVT3 of the electronic fuse circuits 100[1]-100[3] are commonly coupled to a node ND4. The temperature monitoring pin PVT1 is coupled to the ground voltage GND through a resistor R3. The temperature monitoring pin PVT2 is coupled to the ground voltage GND through a resistor R7. The temperature monitoring pin PVT3 is coupled to the ground voltage GND through a resistor R11.

The soft start pin PSS1 of the electronic fuse circuit 100[1] is coupled to the ground voltage GND through a capacitor C1. The soft start pin PSS2 of the electronic fuse circuit 100[2] is coupled to the ground voltage GND through a capacitor C2. The soft start pin PSS3 of the electronic fuse circuit 100[3] is coupled to the ground voltage GND through a capacitor C3. The current-limiting pin PCL1 of the electronic fuse circuit 100[1] is coupled to the ground voltage GND through a resistor R4. The current-limiting pin PCL2 of the electronic fuse circuit 100[2] is coupled to the ground voltage GND through a resistor R8. The current-limiting pin PCL3 of the electronic fuse circuit 100[3] is coupled to the ground voltage GND through a resistor R12.

Notably, since the electronic fuse circuit 100 can self-adaptively control the output current IOUT according to the output current IOUT and/or the junction temperature of the fuse switch 102, the user does not need to manually apply individual settings to the resistance(s) of exterior resistor(s) and/or the capacitance(s) of exterior capacitor(s) based on the heat dissipation ability of each electronic fuse circuit 100 and the distribution of heat sources around each electronic fuse circuit 100. Accordingly, the resistors R1, R5 and R9 can have the same resistance. The resistors R2, R6 and R10 can have the same resistance. The resistors R3, R7 and R11 can have the same resistance. The resistors R4, R8 and R12 can have the same resistance. Also, the capacitors C1, C2 and C3 can have the same resistance. From these descriptions, it can be seen that by using multiple electronic fuse circuits 100 of the present disclosure to compose the fuse circuitry 200, the complexity of producing materials can be reduced, and the common material ratio can be increased, which is more conducive to shortening of the time schedule of research and development and decrease in the cost of research and development.

From the descriptions of the current detection circuit 103 of FIG. 1, it can be seen that the electronic fuse circuits 100[1]-100[3] would output multiple sensing currents ISEN1 by the current monitoring pins PIM1-PIM3, respectively. The sensing currents ISEN1 outputted by the electronic fuse circuits 100[1]-100[3] can be all the same or all different, or can be partially the same and partially different. The sensing currents ISEN1 are summed up at the node ND3, and then the current which is obtained by summing up the sensing currents ISEN1 passes through the resistor R2, the resistor R6 and the resistor R10. In such arrangements, an average current voltage IMON as shown in FIG. 1 is generated at the node ND3 and then provided to the electronic fuse circuits 100[1]-100[3] through the current monitoring pins PIM1-PIM3, respectively. The average current voltage IMON is a voltage form of an average current (not shown) of the sensing currents ISEN1 outputted by the electronic fuse circuits 100[1]-100[3], and also represents an average output current IAVG of the respective fuse switches 102 of the electronic fuse circuits 100[1]-100[3] (i.e., the average of the output currents IOUT).

In accordance with the above descriptions, the electronic fuse circuits 100[1]-100[3] would output multiple sensing currents ISEN2 by the current sensing pins PCS1-PCS3, respectively. The sensing currents ISEN2 outputted by the electronic fuse circuits 100[1]-100[3] can be all the same or all different, or can be partially the same and partially different. The sensing current ISEN2 outputted by the electronic fuse circuit 100[1] passes through the resistor R1. The sensing current ISEN2 outputted by the electronic fuse circuit 100[2] passes through the resistor R5. The sensing current ISEN2 outputted by the electronic fuse circuit 100[3] passes through the resistor R9. In such way, a current sensing voltage CS as shown in FIG. 1 is generated at the current sensing pin PCS of the electronic fuse circuit 100. The current sensing voltage CS represents the respective output current IOUT of the fuse switch 102.

From the descriptions of the temperature reporting circuit 106 of FIG. 1, it can be seen that the temperature reporting circuit 106 can provide one of the temperature dependent voltage V_TJ and the temperature dependent current 322 to the temperature monitoring pin PVT. In particular, the temperature reporting circuit 106 can select one of the temperature dependent voltage V_TJ and the temperature dependent current 322 according to the external connection pattern of the temperature monitoring pin PVT. In the embodiments of FIG. 2, the external connection pattern of the temperature monitoring pin PVT is an average junction temperature reporting configuration. Accordingly, the temperature reporting circuit 106 selects to provide the temperature dependent current 322 to the temperature monitoring pin PVT.

In other words, the electronic fuse circuits 100[1]-100[3] output the respective temperature dependent currents 322 through the temperature monitoring pins PVT1-PVT3, respectively. The temperature dependent currents 322 outputted by the electronic fuse circuits 100[1]-100[3] can be all the same or all different, or can be partially the same and partially different. The temperature dependent currents 322 are summed up at the node ND4, and then the current which is obtained by summing up the temperature dependent currents 322 passes through the resistor R3, the resistor R7 and the resistor R11. In such arrangements, the temperature monitoring voltage VTEMP as shown in FIG. 1 is generated at the node ND4, and is provided for the electronic fuse circuits 100[1]-100[3] through the temperature monitoring pins PVT1-PVT3. In response to the average junction temperature reporting configuration of FIG. 2, the temperature monitoring voltage VTEMP is a voltage form of an average current of the temperature dependent currents 322 outputted by the electronic fuse circuits 100[1]-100[3], and also represents an average junction temperature of the respective fuse switches 102 of the electronic fuse circuits 100[1]-100[3] (i.e., the average of the junction temperatures of the fuse switches 102 of the electronic fuse circuits 100[1]-100[3]).

In addition, by the corresponding one of the capacitors C1-C3 of FIG. 2, the soft start voltage SS is generated at the soft start pin PSS of each electronic fuse circuit 100, which would be further described in detail later. By the corresponding one of the resistors R4, R8 and R12, a current-limiting voltage CL as shown in FIG. 1 is generated at the current-limiting pin PCL of each electronic fuse circuit 100, which would be further described in detail later.

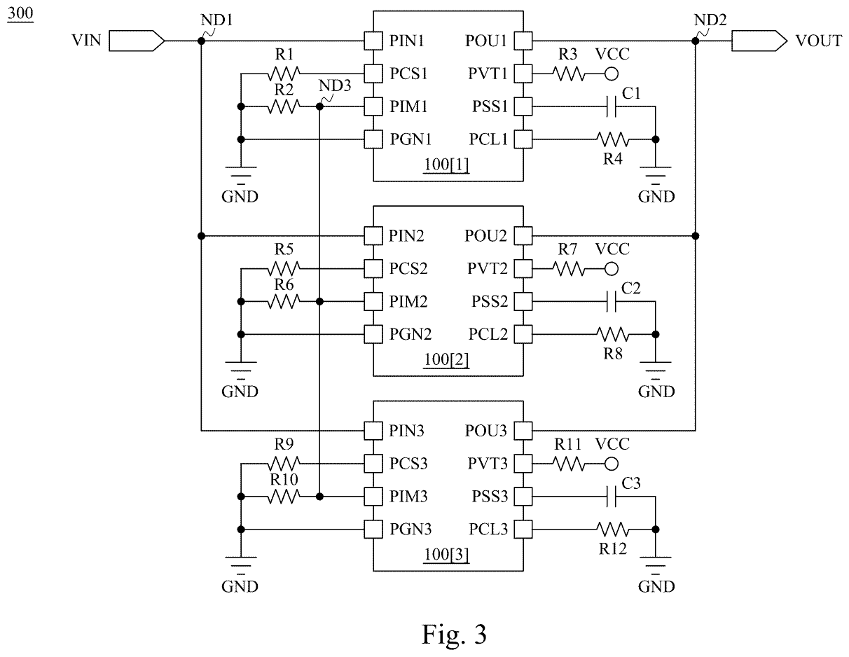

Referring to FIG. 3, FIG. 3 is a circuit block diagram of a fuse circuitry 300 in accordance with some embodiments of the present disclosure. The difference between the fuse circuitry 300 of FIG. 3 and the fuse circuitry 200 of FIG. 2 is the external connection pattern of the temperature monitoring pin PVT of the electronic fuse circuit 100.

In the embodiments of FIG. 3, the temperature monitoring pins PVT1-PVT3 of the electronic fuse circuits 100[1]-100[3] are coupled to a power voltage VCC through the resistors R3, R7 and R11, respectively. In this case, the external connection pattern of the temperature monitoring pin PVT is an individual junction temperature reporting configuration. Accordingly, the temperature reporting circuit 106 selects to provide the temperature dependent voltage V_TJ to the temperature monitoring pin PVT as the temperature monitoring voltage VTEMP. In response to the individual junction temperature reporting configuration of FIG. 3, the temperature monitoring voltage VTEMP represents the junction temperature of the fuse switch 102 of the electronic fuse circuit 100.

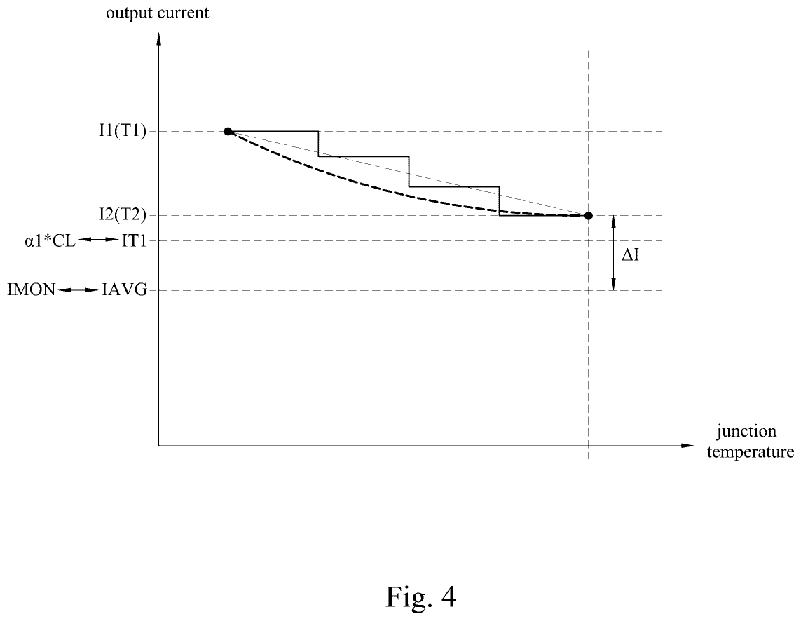

Referring to FIG. 4, FIG. 4 is a relation curve diagram of the output current IOUT and the junction temperature of the fuse switch 102 in accordance with some embodiments of the present disclosure. In some embodiments, it is detected that the output current IOUT has a current level I1 at a time point T1. As shown in FIG. 4, the current level I1 is greater than the current threshold IT1. Therefore, the current control circuit 107 adjusts the voltage level of the main control node 123 downward with the sinking current ISINK1, so as to decrease the output current IOUT.

In accordance with the above descriptions, in some embodiments, it is detected that the output current IOUT has a current level I2 at a time point T2 which occurs after the time point T1. As shown in FIG. 4, the current level I2 is substantially the same as the target current level, that is, the current level I2 is substantially the same as the average output current IAVG plus a current increment ΔI (which would be further described later). Therefore, the current control circuit 107 controls the voltage level of the main control node 123 with the sinking current ISINK1, so that the output current IOUT is no longer decreased or is maintained to be the same as the target current level. Accordingly, it can be seen that the target current level can be greater than the average output current IAVG of the electronic fuse circuits 100[1]-100[3]. From the descriptions of the average current voltage IMON, it can be seen that the average output current IAVG corresponds to the average current voltage IMON. Therefore, when the output currents IOUT of the electronic fuse circuits 100[1]-100[3] are not in balance, the difference among the output currents IOUT of the electronic fuse circuits 100[1]-100[3] can be decreased or eliminated by adjusting the output current IOUT downward to the average output current IAVG plus the current increment ΔI.

In some embodiments, the current threshold IT1 can correspond to α1 times the current-limiting voltage CL, where α1 is between 0 and 1. Also, from the descriptions of the current sensing voltage CS, it can be seen that the current sensing voltage CS corresponds to the output current of the fuse switch 102. Therefore, the electronic fuse circuit 100 can determine whether the output current IOUT is greater than the current threshold IT1 by comparing the current sensing voltage CS with α1 times the current-limiting voltage CL. In addition, in the embodiments of FIG. 4, the approaches for adjusting the output current IOUT from the current level I1 to the current level I2 can be any one of a linear downward adjustment (presented with dot-dashed lines in FIG. 4), a non-linear downward adjustment (presented with broken lines in FIG. 4) and a stepped downward adjustment (presented with solid lines in FIG. 4).

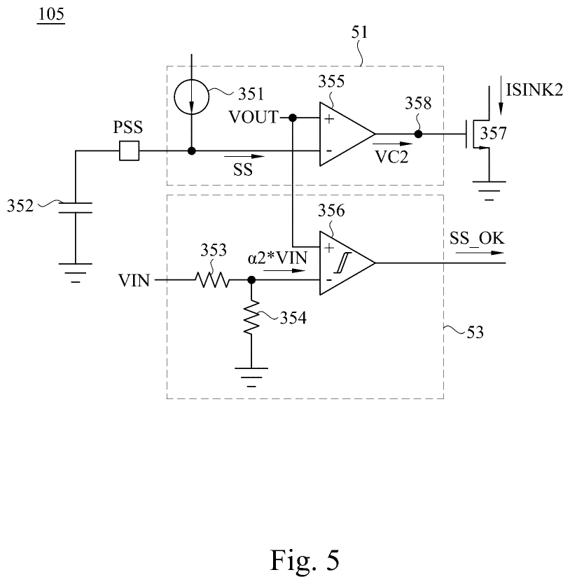

Referring to FIG. 5, FIG. 5 is a circuit schematic diagram of the soft start circuit 105 in accordance with some embodiments of the present disclosure. In some embodiments, the soft start circuit 105 includes a switch 357, a switch control circuit 51 and an indication circuit 53. The switch 357 can be implemented by a transistor (e.g., N type metal oxide semiconductor transistor), but the present disclosure is not limited thereto. In particular, a first terminal (e.g., a drain terminal) of the switch 357 is coupled to the main control node 123 of FIG. 1, a second terminal (e.g., a source terminal) thereof is coupled to the ground voltage GND, and a control terminal (e.g., a gate terminal) thereof is coupled to a sub control node 358. In such arrangements, the switch 357 can generate the sinking current ISINK2 and adjust the sinking current ISINK2 according to a voltage level of the sub control node 358 (i.e., the voltage level of the control terminal of the switch 357).

The switch control circuit 51 includes a current source 351 and an amplifier circuit 355. The current source 351 is coupled to the soft start pin PSS and a negative input terminal (presented with “−” in the drawings) of the amplifier circuit 355. In FIG. 5, a capacitor 352 coupled to the soft start pin PSS is used to present any one of the capacitors C1-C3 in FIG. 2 or 3. The current source 351 can charge the capacitor 352 with a fixed current, so as to generate the soft start voltage SS at the soft start pin PSS. It should be understood that the soft start voltage SS rises in a fixed rising slope. A positive input terminal (presented with “+” in the drawings) of the amplifier circuit 355 can be coupled to the output pin POU to receive the output voltage VOUT. An output terminal of the amplifier circuit 355 is coupled to the sub control node 358. In such way, the amplifier circuit 355 can generate a switch control signal VC2 to the sub control node 358 according to a difference value between the output voltage VOUT and the soft start voltage SS. The amplifier circuit 355 can be implemented by electronic circuit elements, such as an operational amplifier, an error amplifier, etc.

The indication circuit 53 includes a comparator 356, a resistor 353 and a resistor 354. The resistor 353 can be coupled to the input pin PIN to receive the input voltage VIN and further to a negative terminal (−) of the comparator 356. The resistor 354 is coupled to the negative terminal of the comparator 356 and the ground voltage GND. In such arrangements, the resistors 353 and 354 can compose a voltage divider circuit. The voltage divider circuit is configured to generate a divided voltage at the negative terminal of the comparator 356 according to the input voltage VIN, and the divided voltage can be α2 times the input voltage VIN, where α2 is between 0 and 1. It should be understood that α2 is the resistance of the resistor 354 divided by a sum of the resistances of the resistors 353 and 354. A positive input terminal (+) of the comparator 356 can be coupled to the output pin POU to receive the output voltage VOUT. The comparator 356 is configured to generate the indication signal SS_OK according to the output voltage VOUT and the divided voltage.

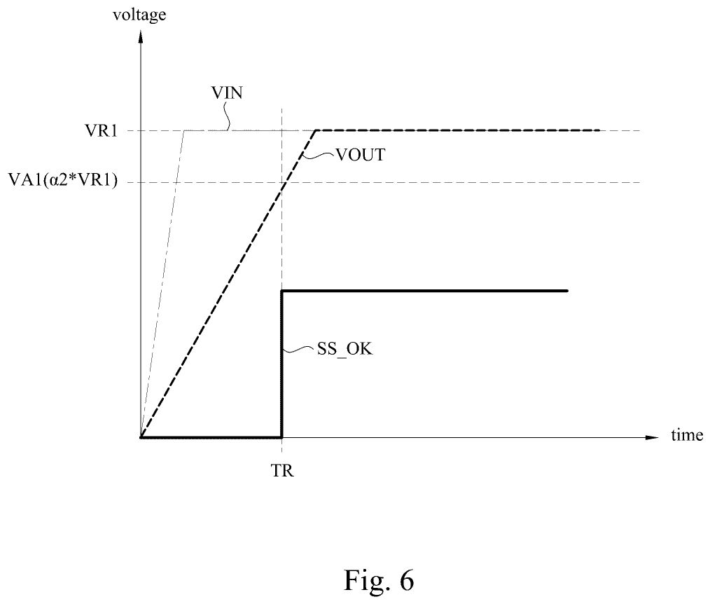

The operations of the soft start circuit 105 would be described below with reference to FIG. 6. FIG. 6 is a signal timing diagram of the input voltage VIN, the output voltage VOUT and the indication signal SS_OK in accordance with some embodiments of the present disclosure. In some embodiments, when the electronic fuse circuit 100 is just activated, the electronic fuse circuit 100 starts executing the soft start operation. During a period of the soft start operation (e.g., the period before a time point TR in FIG. 6), the input voltage VIN starts increasing towards an operating voltage level VR1, and the charge pump circuit 101 of FIG. 1 also starts providing the pull-up current IPULL according to the input voltage VIN, to adjust the voltage level of the main control node 123 upward. Accordingly, the fuse switch 102 of FIG. 1 is in the partial turn-on state due to the increment of the voltage level of the main control node 123, so that the output voltage also starts increasing.

In accordance with the above descriptions, in the initial stage of the soft start operation, the rising slope of the output voltage VOUT is greater than the fixed rising slope of the soft start voltage SS. That is to say, the output voltage VOUT would exceed the soft start voltage SS soon after the electronic fuse circuit 100 is activated. Accordingly, the difference value between the output voltage VOUT and the soft start voltage SS is positive and gradually increased, so that the amplifier circuit 355 increases the voltage level of the switch control signal VC2 (i.e., the voltage level of the sub control node 358). Since the voltage level of the sub control node 358 is increased, the switch 357 is turned on, and the sinking current ISINK2 flows out of the main control node 123 and through the switch 357. The current level of the sinking current ISINK2 can be increased as the increment of the voltage level of the sub control node 358, so as to adjust the voltage level of the main control node 123 downward. By the sinking current ISINK2, the increment of the voltage level of the main control node 123 is slowed down, so that the rising slope of the output voltage VOUT is decreased, which causes the difference value between the output voltage VOUT and the soft start voltage SS to be decreased but still positive. Then, the amplifier circuit 355 adjusts the voltage level of the sub control node 358 downward through the switch control signal VC2, so as to decrease the current level of the sinking current ISINK2, which causes the magnitude of the downward adjustment of the voltage level of the main control node 123 to be decreased. By analogy, the rising slope of the output voltage VOUT is substantially the same as the fixed rising slope of the soft start voltage SS eventually. From these descriptions, it can be seen that the output voltage VOUT is increased according to the fixed rising slope of the soft start voltage SS when the output voltage VOUT does not reach the operating voltage level VR1.

Furthermore, as shown in FIG. 6, after the period of the soft start operation (i.e., after the time point TR), the output voltage VOUT is gradually increased, and reaches the operating voltage level VR1, and the soft start voltage SS exceeds the output voltage VOUT having the operating voltage level VR1. That is to say, the difference value between the output voltage VOUT and the soft start voltage SS is negative, so that the amplifier circuit 355 controls the switch control signal VC2 to have the disable voltage level (i.e., the voltage level of the sub control node 358 is 0 volt). Accordingly, the switch 357 is turned off, and the soft start circuit 105 no longer adjusts the voltage level of the main control node 123 downward with the sinking current ISINK2.

In brief, the switch control circuit 51 is configured to adjust the voltage level of the sub control node 358 according to the difference value between the output voltage VOUT and the soft start voltage SS, so that the rising slope of the output voltage VOUT being lower than the operating voltage level VR1 is substantially the same as the fixed rising slope of the soft start voltage SS.

In addition, before the time point TR, the output voltage VOUT is smaller than the input voltage VIN. In particular, during a period when the input voltage has the operating voltage level VR1 before the time point TR, the voltage level of the output voltage VOUT is smaller a starting voltage level VA1 (which is α2 times the operating voltage level VR1, that is, α2 times the input voltage VIN with the operating voltage level VR1). Accordingly, the comparator 356 outputs the indication signal SS_OK with the disable voltage level based on a comparison result that the output voltage VOUT is smaller than the starting voltage level VA1. The indication signal SS_OK with the disable voltage level can indicate that the soft start operation of the electronic fuse circuit 100 is still being executed or that the voltage level of the output voltage VOUT is smaller than the starting voltage level VA1. After the time point TR, the voltage level of the output voltage VOUT exceeds the starting voltage level VA1, so that the comparator 356 outputs the indication signal SS_OK with an enable voltage level. The indication signal SS_OK with the enable voltage level can indicate that the soft start operation of the electronic fuse circuit 100 is finished or indicate that the voltage level of the output voltage VOUT is greater than the starting voltage level VA1.

From the above descriptions of the soft start circuit 105, it can be seen that the soft start circuit 105 is configured to control the output voltage VOUT to be increased according to the fixed rising slope of the soft start voltage SS when the output voltage VOUT does not reach the operating voltage level VR1. The soft start circuit 105 is further configured to output the indication signal SS_OK according to the voltage level of the output voltage VOUT, to indicate whether the soft start operation of the electronic fuse circuit 100 is being executed or not, or to indicate a relationship between the output voltage VOUT and the starting voltage level VA1.

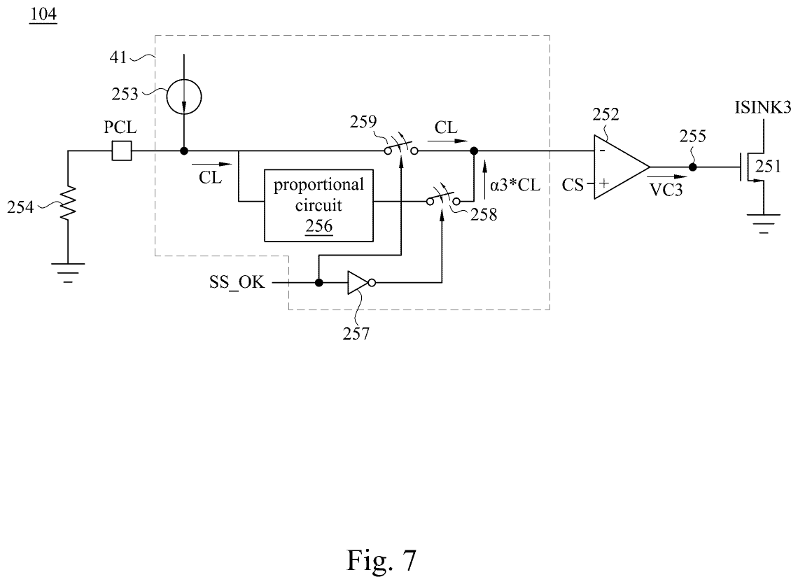

Referring to FIG. 7, FIG. 7 is a circuit schematic diagram of the current-limiting circuit 104 in accordance with some embodiments of the present disclosure. In some embodiments, the current-limiting circuit 104 includes a switch 251, an amplifier circuit 252 and a determination circuit 41.

The switch 251 can be implemented by a transistor (e.g., N type metal oxide semiconductor transistor), but the present disclosure is not limited thereto. In particular, a first terminal (e.g., a drain terminal) of the switch 251 is coupled to the main control node 123 of FIG. 1, a second terminal (e.g., a source terminal) of the switch 251 is coupled to the ground voltage GND, and a control terminal (e.g., a gate terminal) of the switch 251 is coupled to a sub control node 255. In such arrangements, the switch 251 can generate the sinking current ISINK3, and can adjust the sinking current ISINK3 according to a voltage level of the sub control node 255 (i.e., the voltage level of the control terminal of the switch 251).

The determination circuit 41 includes a current source 253, a proportional circuit 256, a NOT gate 257 and switch circuits 258 and 259. The current source 253 is coupled to the current-limiting pin PCL. In FIG. 7, a resistor 254 coupled to the current-limiting pin PCL is used to present any one of the resistors R1, R8 and R12 in FIG. 2 or 3. The current source 253 can provide a fixed current (not shown) passing through the resistor 254, so as to generate the current-limiting voltage CL at the current-limiting pin PCL. The switch circuit 259 is coupled to the current-limiting pin PCL and a negative terminal of the amplifier circuit 252 and controlled by the indication signal SS_OK to be turned on or off. The proportional circuit 256 and the switch circuit 258 are connected in series, and the series circuit consisting of the proportional circuit 256 and the switch circuit 258 is connected in parallel with the switch circuit 259 between the current-limiting pin PCL and the negative terminal of the amplifier circuit 252. The switch circuit 258 is further coupled to the NOT gate 257 and controlled by the inversion of the indication signal SS_OK to be turned on or off.

In accordance with the above descriptions, a positive input terminal of the amplifier circuit 252 is coupled to the current sensing pin PCS to receive the current sensing voltage CS. An output terminal of the amplifier circuit 252 is coupled to the sub control node 255 to generate a switch control signal VC3 to the sub control node 255. The amplifier circuit 252 can be implemented by electronic circuit elements, such as an operational amplifier, an error amplifier, etc.

In some embodiments, when the indication signal SS_OK is at the disable voltage level, the switch circuit 258 is turned on, and the switch circuit 259 is turned off. In this case, the current-limiting voltage CL is multiplied by a preset ratio (e.g., α3 between 0 and 1) through the proportional circuit 256 as an input of the negative terminal of the amplifier circuit 252. It should be understood that the proportional circuit 256 can be implemented by a voltage divider circuit. In some embodiments, when the indication signal SS_OK is at the enable voltage level, the switch circuit 258 is turned off, and the switch circuit 259 is turned on. In this case, the current-limiting voltage CL is directly used as the input of the negative terminal of the amplifier circuit 252. In brief, the determination circuit 41 is coupled to the amplifier circuit 252, the current-limiting pin PCL and the soft start circuit 105 and configured to output one of the current-limiting voltage CL and α3 times the current-limiting voltage CL according to the indication signal SS_OK.

When the soft start operation of the electronic fuse circuit 100 is still being executed, the amplifier circuit 252 adjusts the voltage level of the sub control node 255 through the switch control signal VC3 according to a difference value between the current sensing voltage CS and α3 times the current-limiting voltage CL, so that the switch 251 adjusts the current level of the sinking current ISINK3. For example, when the difference value between the current sensing voltage CS and α3 times the current-limiting voltage CL is positive and gradually increased, the amplifier circuit 252 increases the voltage level of the switch control signal VC3 (i.e., the voltage level of the sub control node 255), to increase the current level of the sinking current ISINK3. Therefore, the magnitude of the downward adjustment of the voltage level of the main control node 123 is increased, which causes the current level of the output current IOUT to be decreased. Because the current level of the output current IOUT is decreased, the voltage level of the current sensing voltage CS is decreased, which causes the difference value between the current sensing voltage CS and α3 times the current-limiting voltage CL to be decreased but still positive. By analogy, the current sensing voltage CS would be substantially the same as α3 times the current-limiting voltage CL.

Moreover, when the soft start operation of the electronic fuse circuit 100 is finished, the amplifier circuit 252 adjusts the voltage level of the sub control node 255 through the switch control signal VC3 according to the difference value between the current sensing voltage CS and the current-limiting voltage CL, so that the switch 251 adjusts the current level of the sinking current ISINK3. It should be understood that, by the amplifier circuit 252, the current sensing voltage CS would be substantially the same as the current-limiting voltage CL.

In the above embodiments, the current sensing voltage CS corresponds to the output current IOUT, and the current-limiting voltage CL and α3 times the current-limiting voltage CL correspond to two current limit values with different levels, respectively. Therefore, making the current sensing voltage CS substantially the same as one of the current-limiting voltage CL and α3 times the current-limiting voltage CL is equivalent to controlling the output current IOUT to not exceed one of the current limit values.

From the above descriptions of the current-limiting circuit 104, it can be seen that the current-limiting circuit 104 is configured to control the output current IOUT to not exceed a first one of the two current limit values (corresponding to α3 times the current-limiting voltage CL) when the output voltage VOUT is lower than the starting voltage level VA1. The current-limiting circuit 104 is further configured to control the output current IOUT to not exceed a second one of the two current limit values (corresponding to the current-limiting voltage CL) when the output voltage VOUT exceeds the starting voltage level VA1. Furthermore, the second one of the two current limit values is greater than the first one of the two current limit values.

As shown in FIG. 6 again, during the execution duration of the soft start operation, a voltage difference between the input voltage VIN and the output voltage VOUT is large, which may result in damage to the fuse switch 102 due to its excessive power consumption. Notably, the current-limiting circuit 104 controls the output current IOUT according to a smaller current limit value (corresponding to α3 times the current-limiting voltage CL) during the execution duration of the soft start operation, which avoids the excessive power consumption of the fuse switch 102.

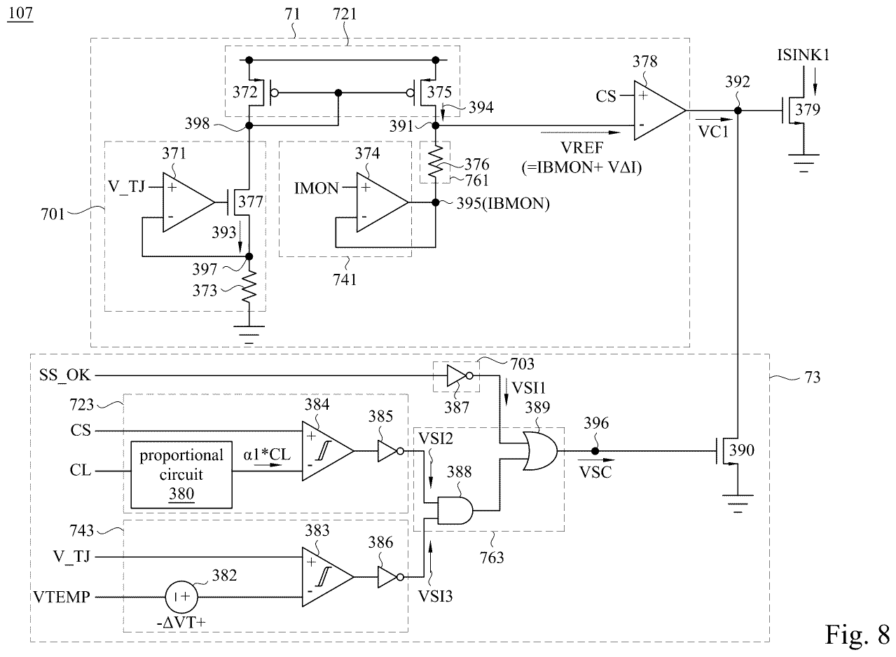

Referring to FIG. 8, FIG. 8 is a circuit schematic diagram of the current control circuit 107 in accordance with some embodiments of the present disclosure. In some embodiments, the current control circuit 107 includes a switch 379, a switch control circuit 71 and a control enable circuit 73.

The switch 379 can be implemented by a transistor (e.g., N type metal oxide semiconductor transistor), but the present disclosure is not limited thereto. In particular, a first terminal (e.g., a drain terminal) of the switch 379 is coupled to the main control node 123 of FIG. 1, a second terminal (e.g., a source terminal) thereof is coupled to the ground voltage GND, and a control terminal (e.g., a gate terminal) thereof is coupled to a sub control node 392. In such arrangements, the switch 379 can generate the sinking current ISINK1 and adjust the sinking current ISINK1 according to a voltage level of the sub control node 392 (i.e., the voltage level of the control terminal of the switch 379).

As shown in FIG. 8, the switch control circuit 71 includes a current generation circuit 701, a current mirror circuit 721, a buffer circuit 741, a voltage difference generation circuit 761 and an amplifier circuit 378.

The current generation circuit 701 includes an amplifier 371, a resistor 373 and a transistor 377, in which the transistor 377 can be implemented by an N type metal oxide semiconductor transistor. A positive terminal of the amplifier 371 can be coupled to the temperature reporting circuit 106 of FIG. 1 to receive the temperature dependent voltage V_TJ, and a negative terminal thereof is coupled to a node 397. A source terminal of the transistor 377 is coupled to the node 397. The resistor 373 is coupled to the node 397 and the ground voltage GND. An output terminal of the amplifier 371 is coupled to a gate terminal of the transistor 377. A drain terminal of the transistor 377 is coupled to a node 398. In such arrangements, when the temperature dependent voltage V_TJ is increased, the amplifier 371 controls the transistor 377 to be turned on. When the transistor 377 is turned on, a temperature dependent current 393 is generated and flows through a transistor 372, the transistor 377 and the resistor 373 sequentially, so that a voltage (not shown) of the node 397 gradually approaches the temperature dependent voltage V_TJ. When the temperature dependent voltage V_TJ is changed as the change in the junction temperature of the fuse switch 102, the temperature dependent current 393 is changed, so that the voltage of the node 397 is also changed. From these descriptions, it can be seen that the current generation circuit 701 generates the temperature dependent current 393 according to the temperature dependent voltage V_TJ related to the junction temperature of the fuse switch 102.

The current mirror circuit 721 includes transistors 372 and 375, in which the transistors 372 and 375 each can be implemented by a P type metal oxide semiconductor transistor. A drain terminal of the transistor 372, a gate terminal of the transistor 372 and a gate terminal of the transistor 375 are coupled to the output terminal of the amplifier 371 together. A source terminal of the transistor 372 and a source terminal of the transistor 375 can receive a proper bias voltage (e.g., the input voltage VIN). A drain terminal of the transistor 375 is coupled to a reference node 391. In such arrangements, the drain terminal of the transistor 375 outputs a temperature dependent current 394 to the reference node 391. In this embodiment, the temperature dependent current 394 is substantially the same as the temperature dependent current 393. From these descriptions, it can be seen that the current mirror circuit 721 is coupled to the current generation circuit 701 and the reference node 391, and copies the temperature dependent current 393 to generate the temperature dependent current 394 to the reference node 391.

The buffer circuit 741 includes an amplifier 374. A positive terminal of the amplifier 374 can be coupled to the current monitoring pin PIM to receive the average current voltage IMON. A negative terminal and an output terminal of the amplifier 374 are coupled to a reference node 395. In such way, the buffer circuit 741 can buffer the average current voltage IMON to generate a buffered average current voltage IBMON at the reference node 395. It should be understood that the buffered average current voltage IBMON is substantially the same as the average current voltage IMON.

The voltage difference generation circuit 761 includes a resistor 376. The resistor 376 is coupled to the current mirror circuit 721 at the reference node 391 and further coupled to the buffer circuit 741 at the reference node 395. The resistor 376 receives the temperature dependent current 394 from the reference node 391. Accordingly, the temperature dependent current 394 flows to the reference node 395 through the resistor 376, so as to generate a temperature dependent voltage difference VΔI between the reference nodes 391 and 395. Because the buffer circuit 741 maintains the reference node 395 at the buffered average current voltage IBMON, a reference voltage VREF is generated at the reference node 391. As shown in FIG. 8, the reference voltage VREF is the buffered average current voltage IBMON plus the temperature dependent voltage difference VΔI. From these descriptions, it can be seen that the voltage difference generation circuit 761 generates the temperature dependent voltage difference VΔI according to the temperature dependent current 394 for generating the reference voltage VREF at the reference node 391.

The amplifier circuit 378 can be implemented by electronic circuit elements, such as an operational amplifier, an error amplifier, etc. A negative terminal of the amplifier circuit 378 is coupled to the reference node 391 to receive the reference voltage VREF. A positive terminal of the amplifier circuit 378 can be coupled to the current sensing pin PCS to receive the current sensing voltage CS. An output terminal of the amplifier circuit 378 is coupled to the sub control node 392, to generate a switch control signal VC1 to the sub control node 392.

In accordance with the above descriptions, the amplifier circuit 378 adjusts the voltage level of the sub control node 392 through the switch control signal VC1 according to a difference value between the current sensing voltage CS and the reference voltage VREF, so that the switch 379 adjusts the current level of the sinking current ISINK1. For example, when the difference value between the current sensing voltage CS and the reference voltage VREF is positive and gradually increased, the amplifier circuit 378 increases the voltage level of the switch control signal VC1 (i.e., the voltage level of the sub control node 392), so as to increase the current level of the sinking current ISINK1. Therefore, the magnitude of the downward adjustment of the voltage level of the main control node 123 is increased, which causes the current level of the output current IOUT to be decreased. Because the current level of the output current IOUT is decreased, the voltage level of the current sensing voltage CS is decreased, which causes the difference value between the current sensing voltage CS and the reference voltage VREF to be decreased but still positive. By analogy, the current sensing voltage CS would be substantially the same as the reference voltage VREF.

In the above embodiments, the current sensing voltage CS corresponds to the output current IOUT, and the reference voltage VREF corresponds to the target current level (i.e., the current level I2 as shown in FIG. 4). Therefore, making the current sensing voltage CS substantially the same as the reference voltage VREF is equivalent to controlling the output current IOUT to be substantially the same as the average output current IAVG plus the current increment ΔI.

From the descriptions of the switch control circuit 71, it can be seen that the switch control circuit 71 is coupled to the temperature reporting circuit 106, the current monitoring pin PIM, the current sensing pin PCS and the sub control node 392. The switch control circuit 71 is configured to adjust the voltage level of the sub control node 392 according to the output current IOUT, the average current voltage IMON and the temperature dependent voltage V_TJ, so that the output current IOUT is substantially the same as the target current level.

As shown in FIG. 8, the control enable circuit 73 includes an indication circuit 703, an indication circuit 723, an indication circuit 743, a sub switch control circuit 763 and a sub switch 390.

The indication circuit 703 includes a NOT gate 387. The NOT gate 387 can be coupled to the soft start circuit 105 to receive the indication signal SS_OK. The NOT gate 387 further inverts the indication signal SS_OK as an indication signal VSI1. In brief, according to the indication signal SS_OK, the indication circuit 703 generates the indication signal VSI1 which presents the state of the soft start operation of the electronic fuse circuit 100. It should be understood that like the indication signal SS_OK, the indication signal VSI1 can be used to indicate whether the soft start operation of the electronic fuse circuit 100 is finished. For example, the indication signal VSI1 with the disable voltage level presents that the soft start operation of the electronic fuse circuit 100 is finished, and the indication signal VSI1 with the enable voltage level presents that the soft start operation of the electronic fuse circuit 100 is not finished yet.

The indication circuit 723 includes a proportional circuit 380, a comparator 384 and a NOT gate 385. The proportional circuit 380 is coupled to the current-limiting pin PCL to receive the current-limiting voltage CL, and multiplies the current-limiting voltage CL by a preset ratio (e.g., α1 between 0 and 1) as an output (i.e., α1 times the current-limiting voltage CL). It should be understood that the proportional circuit 380 can be implemented by a voltage divider circuit. A negative terminal of the comparator 384 is coupled to the proportional circuit 380 to receive α1 times the current-limiting voltage CL. A positive terminal of the comparator 384 is coupled to the current sensing pin PCS to receive the current sensing voltage CS. An output terminal of the comparator 384 is coupled to the NOT gate 385, and the comparator 384 outputs a comparison result between the current sensing voltage CS and α1 times the current-limiting voltage CL to the NOT gate 385. The NOT gate 385 is configured to invert the comparison result as an indication signal VSI2. In brief, according to the current-limiting voltage CL and the current sensing voltage CS, the indication circuit 723 generates the indication signal VSI2 which presents a state or a magnitude of the output current IOUT.

Furthermore, as the descriptions of the current threshold IT1, the indication signal VSI2, which is outputted by the indication circuit 723 comparing the current sensing voltage CS with α1 times the current-limiting voltage CL, can indicate whether the output current IOUT is greater than the current threshold IT1. For example, when the current sensing voltage CS is greater than α1 times the current-limiting voltage CL, the indication signal VSI2 has the disable voltage level, which can be used to indicate the output current IOUT is greater than the current threshold IT1. Also, when the current sensing voltage CS is smaller than α1 times the current-limiting voltage CL, the indication signal VSI2 has the enable voltage level, which can be used to indicate the output current IOUT is smaller than the current threshold IT1.

The indication circuit 743 includes a voltage source 382, a comparator 383 and a NOT gate 386. The voltage source 382 can be coupled to the temperature monitoring pin PVT to receive the temperature monitoring voltage VTEMP, and adds a preset voltage difference ΔVT to the temperature monitoring voltage VTEMP as an output. A negative terminal of the comparator 383 is coupled to the voltage source 382 to receive a temperature threshold voltage (i.e., the sum of the temperature monitoring voltage VTEMP plus the preset voltage difference ΔVT). A positive terminal of the comparator 383 is coupled to the temperature reporting circuit 106 of FIG. 1 to receive the temperature dependent voltage V_TJ. An output terminal of the comparator 383 is coupled to the NOT gate 386, and the comparator 383 outputs a comparison result between the temperature threshold voltage and the temperature dependent voltage V_TJ to the NOT gate 386. The NOT gate 386 is configured to invert the comparison result as an indication signal VSI3. In brief, according to the temperature monitoring voltage VTEMP and the temperature dependent voltage V_TJ, the indication circuit 743 generates the indication signal VSI3 which presents a state or a magnitude of the junction temperature of the fuse switch 102.

Furthermore, as the descriptions of the junction temperature of the fuse switch 102 and the temperature threshold, the indication signal VSI3, which is outputted by the indication circuit 743 comparing the temperature threshold voltage with the temperature dependent voltage V_TJ, can indicate whether the junction temperature of the fuse switch 102 is greater than the temperature threshold. For example, when the temperature dependent voltage V_TJ is greater than the temperature threshold voltage, the indication signal VSI3 has the disable voltage level, which can be used to indicate the junction temperature of the fuse switch 102 is greater than the temperature threshold. Also, when the temperature dependent voltage V_TJ is smaller than the temperature threshold voltage, the indication signal VSI3 has the enable voltage level, which can be used to indicate the junction temperature of the fuse switch 102 is smaller than the temperature threshold.

The sub switch control circuit 763 includes an AND gate 388 and an OR gate 389. Two input terminals of the AND gate 388 are coupled to the indication circuit 723 and the indication circuit 743, respectively. Two input terminals of the OR gate 389 are coupled to an output terminal of the AND gate 388 and the indication circuit 703, respectively. An output terminal of the OR gate 389 is coupled to a sub control node 396. In such arrangements, the AND gate 388 can perform an AND operation on the indication signal VSI2 and the indication signal VSI3, and the OR gate 389 can perform an OR operation on the indication signal VSI1 and an operation result of the AND gate 388. An operation result of the OR gate 389 can be used as a sub switch control signal VSC and be outputted to the sub control node 396. In brief, the sub switch control circuit 763 generates the sub switch control signal VSC according to the indication signal VSI1, the indication signal VSI2 and the indication signal VSI3.

The sub switch 390 can be implemented by a transistor (e.g., N type metal oxide semiconductor transistor), but the present disclosure is not limited thereto. In particular, a first terminal (e.g., a drain terminal) of the sub switch 390 is coupled to the sub control node 392, a second terminal (e.g., a source terminal) of the sub switch 390 is coupled to the ground voltage GND, and a control terminal (e.g., a gate terminal) of the sub switch 390 is coupled to the sub control node 396. In such arrangements, the sub switch 390 can be turned on or off according to the sub switch control signal VSC.

In the embodiments of FIG. 8, during the execution duration of the soft start operation of the electronic fuse circuit 100 (e.g., before the time point TR of FIG. 6), the indication signal SS_OK has the disable voltage level, so that the indication signal VSI1 has the enable voltage level. In response to the indication signal VSI1 with the enable voltage level, the sub switch control signal VSC generated by the OR gate 389 has the enable voltage level, so as to turn on the sub switch 390.

In accordance with the above descriptions, when the soft start operation of the electronic fuse circuit 100 is finished (e.g., after the time point TR of FIG. 6), the indication signal SS_OK has the enable voltage level, so that the indication signal VSI1 has the disable voltage level. In this case, when the current sensing voltage CS is greater than α1 times the current-limiting voltage CL and/or the temperature dependent voltage V_TJ is greater than the temperature threshold voltage (i.e., the temperature monitoring voltage VTEMP plus the preset voltage difference ΔVT), a signal (not shown) generated by the AND gate 388 has the disable voltage level. Accordingly, the sub switch control signal VSC generated by the OR gate 389 has the disable voltage level, to turn off the sub switch 390. On the other hand, when the current sensing voltage CS is smaller than α1 times the current-limiting voltage CL as well as the temperature dependent voltage V_TJ is smaller than the temperature threshold voltage, the signal generated by the AND gate 388 has the enable voltage level. Accordingly, the sub switch control signal VSC generated by the OR gate 389 has the enable voltage level, to turn on the sub switch 390.

From the descriptions of the switch control circuit 71 and the control enable circuit 73, it can be seen that, during the execution duration of the soft start operation of the electronic fuse circuit 100, the control enable circuit 73 switches the voltage level of the sub control node 392 to the ground voltage GND (which can be regarded as the disable voltage level) by turning the sub switch 390 on, so as to turn off the switch 379. That is to say, during the execution duration of the soft start operation, the current control circuit 107 does not adjust the voltage level of the main control node 123 downward through the sinking current ISINK1.

Also, when the soft start operation of the electronic fuse circuit 100 is finished, the control enable circuit 73 turns the sub switch 390 off in response to at least one of the preset conditions (i.e., the current sensing voltage CS is greater than α1 times the current-limiting voltage CL and/or the temperature dependent voltage V_TJ is greater than the temperature threshold voltage) being satisfied, so as to allow the switch control circuit 71 to adjust the voltage level of the sub control node 392 according to the output current IOUT and the target current level (i.e., the average output current IAVG plus the current increment ΔI as shown in FIG. 4). In other words, the control enable circuit 73 enables the switch control circuit 71 to adjust the voltage level of the sub control node 392, so that the current control circuit 107 can adjust the voltage level of the main control node 123 downward through the sinking current ISINK1.

From the descriptions of the charge pump circuit 101, the soft start circuit 105, the current-limiting circuit 104 and the current control circuit 107, it can be seen that, during the execution duration of the soft start operation of the electronic fuse circuit 100, the charge pump circuit 101 would adjust the voltage level of the main control node 123 upward through the pull-up current IPULL, the soft start circuit 105 would adjust the voltage level of the main control node 123 downward through the sinking current ISINK2, and the current-limiting circuit 104 would adjust the voltage level of the main control node 123 downward through the sinking current ISINK3 when the current sensing voltage CS is greater than α3 times the current-limiting voltage CL (i.e., when the output current IOUT is greater than a smaller one of the two current limit values). That is to say, during the execution duration of the soft start operation of the electronic fuse circuit 100, the voltage level of the output voltage VOUT and the current level of the output current IOUT of the fuse switch 102 are determined by the pull-up current IPULL, the sinking current ISINK2 and the sinking current ISINK3.

In addition, when the soft start operation of the electronic fuse circuit 100 is finished, the charge pump circuit 101 would adjust the voltage level of the main control node 123 upward through the pull-up current IPULL, the current-limiting circuit 104 would adjust the voltage level of the main control node 123 downward through the sinking current ISINK3 when the current sensing voltage CS is greater than the current-limiting voltage CL (i.e., when the output current IOUT is greater than a larger one of the two current limit values), and the current control circuit 107 would adjust the voltage level of the main control node 123 downward through the sinking current ISINK1 when the current sensing voltage CS is greater than α1 times the current-limiting voltage CL (i.e., the output current IOUT is greater than the current threshold IT1) and/or the temperature dependent voltage V_TJ is greater than the temperature threshold voltage (i.e., the junction temperature of the fuse switch 102 is greater than the temperature threshold). That is to say, when the soft start operation of the electronic fuse circuit 100 is finished, the voltage level of the output voltage VOUT and the current level of the output current IOUT of the fuse switch 102 are determined by the pull-up current IPULL, the sinking current ISINK1 and the sinking current ISINK2.

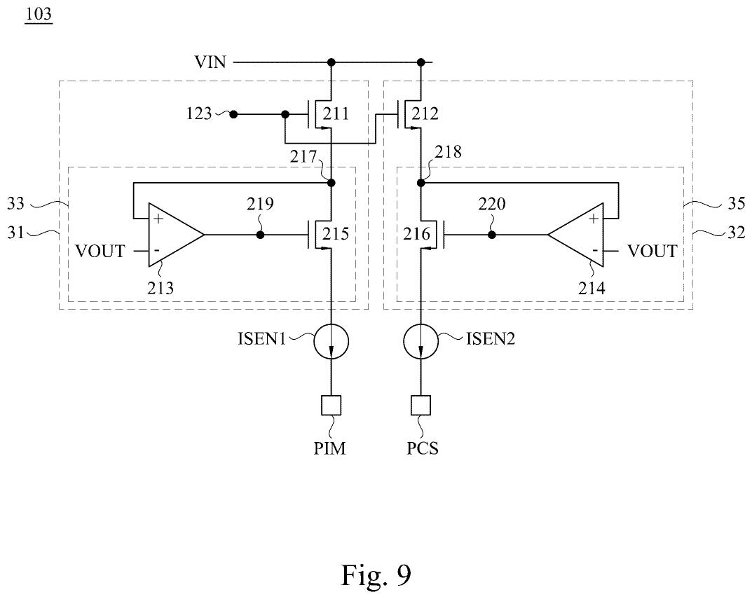

Referring to FIG. 9, FIG. 9 is a circuit schematic diagram of the current detection circuit 103 in accordance with some embodiments of the present disclosure. In some embodiments, the current detection circuit 103 includes current generation circuits 31 and 32.

The current generation circuit 31 includes a transistor 211 and a voltage buffer circuit 33. The voltage buffer circuit 33 includes an amplifier 213 and a transistor 215. Both the transistors 211 and 215 can be implemented by N type metal oxide semiconductor transistors. A negative terminal of the amplifier 213 can be coupled to the output pin POU to receive the output voltage VOUT. A positive terminal of the amplifier 213 is coupled to a drain terminal of the transistor 215 at a node 217. An output terminal of the amplifier 213 is coupled to a gate terminal of the transistor 215 at a node 219. A source terminal of the transistor 215 is coupled to the current monitoring pin PIM. A drain terminal of the transistor 211 can be coupled to the input pin PIN to receive the input voltage VIN. A gate terminal of the transistor 211 is coupled to the main control node 123. A source terminal of the transistor 211 is coupled to the node 217.

By the above configurations of the amplifier 213 and the transistor 215, the voltage buffer circuit 33 can generate a voltage (not shown), which is substantially the same as the output voltage VOUT, at the node 217. Accordingly, three terminals of the transistor 211 correspond to the input voltage VIN, the voltage level of the main control node 123 and the output voltage VOUT, respectively, like three terminals of the fuse switch 102. In such arrangements, the sensing current ISEN1 related to the output current IOUT flows from the source terminal of the transistor 211 and then passes through the transistor 215 to the current monitoring pin PIM.

The current generation circuit 32 includes a transistor 212 and a voltage buffer circuit 35. The voltage buffer circuit 35 includes an amplifier 214 and a transistor 216. Both the transistors 212 and 216 can be implemented by N type metal oxide semiconductor transistors. A negative terminal of the amplifier 214 can be coupled to the output pin POU to receive the output voltage VOUT. A positive terminal of the amplifier 214 is coupled to a drain terminal of the transistor 216 at a node 218. An output terminal of the amplifier 214 is coupled to a gate terminal of the transistor 216 at a node 220. A source terminal of the transistor 216 is coupled to the current sensing pin PCS. A drain terminal of the transistor 212 can be coupled to the input pin PIN to receive the input voltage VIN. A gate terminal of the transistor 212 is coupled to the main control node 123. A source terminal of the transistor 212 is coupled to the node 218.

By the above configurations of the amplifier 214 and the transistor 216, the voltage buffer circuit 35 can generate a voltage (not shown) substantially the same as the output voltage VOUT at the node 218. Accordingly, three terminals of the transistor 212 correspond to the input voltage VIN, the voltage level of the main control node 123 and the output voltage VOUT, respectively, like three terminals of the fuse switch 102. In such arrangements, the sensing current ISEN2 related to the output current IOUT flows from the source terminal of the transistor 212 and passes through the transistor 216 to the current sensing pin PCS.

In the embodiments of FIG. 9, both a channel area of the transistor 211 and a channel area of the transistor 212 are 1/M times a channel area of the fuse switch 102. Thus, both the current level of the sensing current ISEN1 and the current level of the sensing current ISEN2 are 1/M times the current level of the output current IOUT (as the descriptions of FIG. 1).

Referring to FIG. 10, FIG. 10 is a circuit schematic diagram of the temperature reporting circuit 106 in accordance with some embodiments of the present disclosure. In some embodiments, the temperature reporting circuit 106 includes a temperature detection circuit 61, a signal generation circuit 63 and a selection circuit 65.

The temperature detection circuit 61 is arranged near the fuse switch 102, and includes a current source 301 and a transistor 302. The current source 301 is configured to bias the transistor 302. The transistor 302 can be implemented by a NPN type bipolar junction transistor, but the present disclosure is not limited thereto. An emitter terminal of the transistor 302 is coupled to the ground voltage GND. A base terminal of the transistor 302 is coupled to a collector terminal of the transistor 302 and the current source 301. Notably, by the above configurations of the current source 301 and the transistor 302, a base-emitter voltage VBE of the transistor 302 can have a linear relationship with the junction temperature of the fuse switch 102. In other words, the temperature detection circuit 61 can detect the junction temperature of the fuse switch 102 by the transistor 302. As shown in FIG. 10, the temperature detection circuit 61 can output the base-emitter voltage VBE of the transistor 302 as a detection result of the junction temperature of the fuse switch 102.

The signal generation circuit 63 includes an amplifier 303, a transistor 304, a resistor 305, transistors 306-308, an amplifier 3069 and a resistor 310. The transistor 304 can be implemented by an N type metal oxide semiconductor transistor. The transistors 306-308 can be implemented by P type metal oxide semiconductor transistors.

A negative terminal of the amplifier 303 can be coupled to the temperature detection circuit 61 to receive the base-emitter voltage VBE. A positive terminal of the amplifier 303 is coupled to a drain terminal of the transistor 304. An output terminal of the amplifier 303 is coupled to a gate terminal of the transistor 304. A source terminal of the transistor 304 is coupled to the ground voltage GND. Accordingly, the amplifier 303 and the transistor 304 can compose a voltage buffer circuit. The voltage buffer circuit can generate a voltage (not shown) substantially the same as the base-emitter voltage VBE at its output terminal (i.e., the drain terminal of the transistor 304).

The transistors 306-308 can compose a current mirror circuit. A drain terminal and a gate terminal of the transistor 306, a gate terminal of the transistor 307 and a gate terminal of the transistor 308 are coupled to an input terminal of the current mirror circuit together. A source terminal of the transistor 306, a source terminal of the transistor 307 and a source terminal of the transistor 308 can receive a proper bias voltage (e.g., the input voltage VIN). A drain terminal of the transistor 307 and a drain terminal of the transistor 308 can be used as two output terminals of the current mirror circuit, respectively. In addition, the resistor 305 can be coupled to the output terminal of the voltage buffer circuit and the input terminal of the current mirror circuit.

A negative terminal of the amplifier 309 is coupled to an output terminal of the amplifier 309. A positive terminal of the amplifier 309 is coupled between the drain terminal of the transistor 307 and the resistor 310. The resistor 310 is coupled to the drain terminal of the transistor 307, the positive terminal of the amplifier 309 and the ground voltage GND. Accordingly, the amplifier 309 and the resistor 310 can compose a current to voltage conversion circuit.

When the base-emitter voltage VBE is changed as the change in the junction temperature of the fuse switch 102, a voltage difference (not shown) across the resistor 305 is changed, so that a temperature dependent current 316 flowing from the transistor 306 and passing through the resistor 305 to the transistor 304 is also changed. The current mirror circuit composed of the transistors 306-308 then copies the temperature dependent current 316, to output a temperature dependent current (not shown) by the drain terminal of the transistor 307 and to output another temperature dependent current 322 by the drain terminal of the transistor 308.

Moreover, the temperature dependent current outputted from the drain terminal of the transistor 307 passes through the resistor 310, to generate a temperature dependent voltage (not shown) at the positive input terminal of the amplifier 309. The amplifier 309 then generates the temperature dependent voltage V_TJ, which is substantially the same as the temperature dependent voltage, at its output terminal. That is to say, the current to voltage conversion circuit composed of the amplifier 309 and the resistor 310 generates the temperature dependent voltage V_TJ according to the temperature dependent current 316.

The selection circuit 65 includes switch circuits 311 and 312, AND gates 313 and 314, a NOT gate 315, a D flip-flop 317, a one-shot circuit 318 and a comparator 319. The switch circuit 312 is coupled to the drain terminal of the transistor 308 and the temperature monitoring pin PVT and controlled by the AND gate 313. The switch circuit 311 is coupled to the output terminal of the amplifier 309 and the temperature monitoring pin PVT and controlled by the AND gate 314. Both a first input terminal of the AND gate 313 and a first input terminal of the AND gate 314 are configured to receive the indication signal SS_OK. A second input terminal of the AND gate 313 is coupled to a data output terminal Q of the D flip-flop 317 through the NOT gate 315. A second input terminal of the AND gate 314 is directly coupled to the data output terminal Q of the D flip-flop 317.

A data input terminal D of the D flip-flop 317 is coupled to an output terminal of the comparator 319. A positive input terminal of the comparator 319 is coupled to the temperature monitoring pin PVT. A negative input terminal of the comparator 319 is configured to receive a threshold voltage VTR. A clock input terminal CLK of the D flip-flop 317 is coupled to an output terminal of the one-shot circuit 318. An input terminal of the one-shot circuit 318 is configured to receive the indication signal SS_OK.

From the circuit configurations of the selection circuit 65, it can be seen that, during the execution duration of the soft start operation of the electronic fuse circuit 100, both the switch circuits 311 and 312 are turned off. Accordingly, the temperature monitoring voltage VTEMP is not generated at the temperature monitoring pin PVT temporarily. Meanwhile, the voltage level of the temperature monitoring pin PVT is determined according to the external connection pattern of the temperature monitoring pin PVT. For example, in the embodiments of FIG. 2, the voltage level of the temperature monitoring pin PVT is close to or substantially the same as the ground voltage GND and further smaller than the threshold voltage VTR, so that the comparator 319 outputs a comparison signal (not shown) with the disable voltage level to the data input terminal D of the D flip-flop 317. In the embodiments of FIG. 3, the voltage level of the temperature monitoring pin PVT is close to or substantially the same as the power voltage VCC and further greater than the threshold voltage VTR, so that the comparator 319 outputs the comparison signal with the enable voltage level to the data input terminal D of the D flip-flop 317.

Also, when the soft start operation of the electronic fuse circuit 100 is finished, the one-shot circuit 318 is triggered by the indication signal SS_OK with the enable voltage level to generate a pulse signal (not shown) to the clock input terminal CLK of the D flip-flop 317. The D flip-flop 317 is triggered by the pulse signal to output the comparison signal outputted by the comparator 319 through the data output terminal Q.

In accordance with the above descriptions, when the comparison signal has the disable voltage level (i.e., when the external connection pattern of the temperature monitoring pin PVT is the average junction temperature reporting configuration of FIG. 2), the switch circuit 311 is turned off, and the switch circuit 312 is turned on. In such way, the selection circuit 65 provides the temperature dependent current 322 to the temperature monitoring pin PVT, so as to generate the temperature monitoring voltage VTEMP corresponding to the average junction temperature of the fuse switches 102 of the electronic fuse circuits 100 (as the descriptions of FIG. 2). When the comparison signal has the enable voltage level (i.e., when the external connection pattern of the temperature monitoring pin PVT is the individual junction temperature reporting configuration of FIG. 3), the switch circuit 311 is turned on, and the switch circuit 312 is turned off. In such way, the selection circuit 65 provides the temperature dependent voltage V_TJ to the temperature monitoring pin PVT, so as to generate the temperature monitoring voltage VTEMP corresponding to the respective junction temperature of the fuse switch 102 (as the descriptions of FIG. 3).

Although the present disclosure has been described in considerable detail with reference to certain embodiments thereof, other embodiments are possible. Therefore, the spirit and scope of the appended claims should not be limited to the description of the embodiments contained herein. It will be apparent to those skilled in the art that various modifications and variations can be made to the structure of the present disclosure without departing from the scope or spirit of the invention. In view of the foregoing, it is intended that the present invention cover modifications and variations of this invention provided they fall within the scope of the following claims.

What is claimed is:

1. An electronic fuse circuit, comprising:
a fuse switch, coupled to a main control node, configured to generate an output current and an output voltage according to an input voltage, and configured to adjust the output current and the output voltage according to a voltage level of the main control node; and
a current control circuit, coupled to the main control node, and comprising:
a first switch, coupled to the main control node and a first sub control node, configured to generate a first sinking current, and configured to adjust the first sinking current according to a voltage level of the first sub control node, wherein the first sinking current flows out of the main control node, and is configured to adjust the voltage level of the main control node downward;
a first switch control circuit, coupled to the first sub control node, and configured to adjust the voltage level of the first sub control node according to the output current, an average current voltage and a temperature dependent voltage, wherein the average current voltage is related to an average of the output current of the electronic fuse circuit and at least another output current of at least another electronic fuse circuit; and
a control enable circuit, coupled to the first sub control node, and configured to, when the output voltage exceeds a starting voltage level, enable the first switch control circuit to adjust the voltage level of the first sub control node in response to at least one of a plurality of preset conditions being satisfied, wherein the plurality of preset conditions comprise the output current exceeding a current threshold and a junction temperature of the fuse switch exceeding a temperature threshold, and the temperature dependent voltage is related to the junction temperature of the fuse switch.

2. The electronic fuse circuit of claim 1, wherein the first switch control circuit comprises:
a current generation circuit, configured to generate a first temperature dependent current according to the temperature dependent voltage;
a current mirror circuit, coupled to the current generation circuit and a first reference node, and configured to copy the first temperature dependent current to generate a second temperature dependent current to the first reference node;
a buffer circuit, coupled to a second reference node, and configured to buffer the average current voltage, to generate a buffered average current voltage at the second reference node;
a voltage difference generation circuit, coupled to the current mirror circuit and the buffer circuit at the first reference node and the second reference node, respectively, and configured to generate a temperature dependent voltage difference according to the second temperature dependent current, to generate a reference voltage at the first reference node, wherein the reference voltage is the temperature dependent voltage difference plus the buffered average current voltage; and
an amplifier circuit, coupled to the first sub control node and the first reference node, and configured to adjust the voltage level of the first sub control node through a first switch control signal according to a first difference value between the reference voltage and a current sensing voltage related to the output current.

3. The electronic fuse circuit of claim 1, wherein the control enable circuit comprises:
a first indication circuit, configured to generate a second indication signal according to a first indication signal, wherein the first indication signal is configured to indicate a state of a soft start operation of the electronic fuse circuit;
a second indication circuit, configured to generate a third indication signal according to a current-limiting voltage and a current sensing voltage related to the output current, wherein the third indication signal is configured to indicate a state of the output current, the current threshold corresponds to α1 times the current-limiting voltage, and α1 is between 0 and 1;
a third indication circuit, configured to generate a fourth indication signal according to a temperature monitoring voltage and the temperature dependent voltage, wherein the fourth indication signal is configured to indicate the junction temperature of the fuse switch, and the temperature threshold corresponds to the temperature monitoring voltage plus a preset voltage difference;
a sub switch control circuit, coupled to the first indication circuit, the second indication circuit and the third indication circuit, and configured to generate a sub switch control signal according to the second indication signal, the third indication signal and the fourth indication signal; and
a sub switch, coupled to the sub switch control circuit and the first sub control node, and configured to be turned on or off according to the sub switch control signal.

4. The electronic fuse circuit of claim 1, further comprising:
a soft start circuit, coupled to the main control node, configured to control the output voltage to increase according to a fixed rising slope of a soft start voltage when the output voltage does not reach an operating voltage level, and configured to output an indication signal to the control enable circuit of the current control circuit according to a voltage level of the output voltage, wherein the indication signal is configured to indicate a relationship between the output voltage and the starting voltage level, and the operating voltage level is greater than the starting voltage level;
wherein the control enable circuit is configured to switch the voltage level of the first sub control node to a disable voltage level when the output voltage is lower than the starting voltage level, so as to turn off the first switch.

5. The electronic fuse circuit of claim 4, wherein the soft start circuit comprises:
a second switch, coupled to the main control node and a second sub control node, configured to generate a second sinking current, and configured to adjust the second sinking current according to a voltage level of the second sub control node, wherein the second sinking current flows out of the main control node, and is configured to adjust the voltage level of the main control node downward;
a second switch control circuit, coupled to the second sub control node, configured to receive the output voltage and the soft start voltage, and configured to adjust the voltage level of the second sub control node according to the output current and the soft start voltage, so that a rising slope of the output voltage, which is lower than the operating voltage level, is the same as the fixed rising slope of the soft start voltage; and
an indication circuit, configured to receive the input voltage and the output voltage, configured to generate the indication signal with the disable voltage level when the output voltage is lower than the starting voltage level, and configured to generate the indication signal with an enable voltage level when the output voltage exceeds the starting voltage level, wherein the starting voltage level is α2 times the operating voltage level, and α2 is between 0 and 1.

6. The electronic fuse circuit of claim 1, further comprising:
a current-limiting circuit, coupled to the main control node, configured to control the output current to not exceed a first current limit value when the output voltage is lower than the starting voltage level, and configured to control the output current to not exceed a second current limit value when the output voltage exceeds the starting voltage level, wherein the second current limit value is greater than the first current limit value.

7. The electronic fuse circuit of claim 6, wherein the current-limiting circuit comprises:
a second switch, coupled to the main control node and a second sub control node, configured to generate a second sinking current, and configured to adjust the second sinking current according to a voltage level of the second sub control node, wherein the second sinking current flows out of the main control node, and is configured to adjust the voltage level of the main control node downward;
a determination circuit, configured to receive a current-limiting voltage, configured to use α3 times the current-limiting voltage as an output when the output voltage is lower than the starting voltage level, and configured to use the current-limiting voltage as the output when the output voltage exceeds the starting voltage level, wherein α3 is between 0 and 1; and
an amplifier circuit, coupled to the second sub control node and the determination circuit, and configured to adjust the voltage level of the second sub control node through a first switch control signal according to a first difference value between a current sensing voltage related to the output current and the output of the determination circuit, so that the output current is the same as one of the first current limit value and the second current limit value, wherein the first current limit value corresponds to α3 times the current-limiting voltage, and the second current limit value corresponds to the current-limiting voltage.

8. The electronic fuse circuit of claim 1, further comprising:
a current detection circuit, coupled to the main control node and the fuse switch, and configured to detect the output current to output a first sensing current and a second sensing current, wherein the first sensing current is used to generate the average current voltage, the second sensing current is used to generate a current sensing voltage related to the output current, both a voltage level of the first sensing current and a voltage level of the second sensing current are 1/M times a voltage level of the output current, and M is a positive integer greater than 0.

9. The electronic fuse circuit of claim 1, further comprising:
a temperature reporting circuit, disposed near the fuse switch, coupled to the current control circuit, configured to detect the junction temperature of the fuse switch, configured to generate the temperature dependent voltage and a temperature dependent current according to the junction temperature, and configured to provides one of the temperature dependent voltage and the temperature dependent current when the output voltage exceeds the starting voltage level, so as to generate a temperature monitoring voltage, wherein the temperature monitoring voltage is related to the junction temperature of the fuse switch, or is related to an average of the junction temperature of the fuse switch and a junction temperature of at least another fuse switch of the at least another electronic fuse circuit.

10. A fuse circuitry, comprising:
a first electronic fuse circuit, having a first input pin, a first output pin and a first temperature monitoring pin; and
a second electronic fuse circuit, connected in parallel to the first electronic fuse circuit, and having a second input pin, a second output pin and a second temperature monitoring pin;
wherein the first input pin and the second input pin are coupled at a first node together, the first output pin and the second output pin are coupled at a second node together, and each of the first electronic fuse circuit and the second electronic fuse circuit comprises:
a fuse switch, coupled to a main control node, configured to receive an input voltage from the first node, configured to generate an output current according to the input voltage, configured to generate an output voltage at the second node according to the input voltage, and configured to adjust the output current and the output voltage according to a voltage level of the main control node; and
a current control circuit, coupled to the main control node, and comprising:
a first switch, coupled to the main control node and a first sub control node, configured to generate a first sinking current, and configured to adjust the first sinking current according to a voltage level of the first sub control node, wherein the first sinking current flows out of the main control node, and is configured to adjust the voltage level of the main control node downward;
a first switch control circuit, coupled to the first sub control node, and configured to adjust the voltage level of the first sub control node according to the output current, an average current voltage and a temperature dependent voltage, wherein the average current voltage is related to an average of the output current of the first electronic fuse circuit and the output current of the second electronic fuse circuit; and
a control enable circuit, coupled to the first sub control node, and configured to, when the output voltage exceeds a starting voltage level, enable the first switch control circuit to adjust the voltage level of the first sub control node in response to at least one of a plurality of preset conditions being satisfied, wherein the plurality of preset conditions comprise the output current exceeding a current threshold and a junction temperature of the fuse switch exceeding a temperature threshold, and the temperature dependent voltage is related to the junction temperature of the fuse switch.

11. The fuse circuitry of claim 10, wherein the first switch control circuit comprises:
a current generation circuit, configured to generate a first temperature dependent current according to the temperature dependent voltage;
a current mirror circuit, coupled to the current generation circuit and a first reference node, and configured to copy the first temperature dependent current to generate a second temperature dependent current to the first reference node;
a buffer circuit, coupled to a second reference node, and configured to buffer the average current voltage, to generate a buffered average current voltage at the second reference node;
a voltage difference generation circuit, coupled to the current mirror circuit and the buffer circuit at the first reference node and the second reference node, respectively, and configured to generate a temperature dependent voltage difference according to the second temperature dependent current, to generate a reference voltage at the first reference node, wherein the reference voltage is the temperature dependent voltage difference plus the buffered average current voltage; and
an amplifier circuit, coupled to the first sub control node and the first reference node, and configured to adjust the voltage level of the first sub control node through a first switch control signal according to a first difference value between the reference voltage and a current sensing voltage related to the output current.

12. The fuse circuitry of claim 10, wherein the control enable circuit comprises:
a first indication circuit, configured to generate a second indication signal according to a first indication signal, wherein the first indication signal is configured to indicate a state of a soft start operation of the first electronic fuse circuit or the second electronic fuse circuit;
a second indication circuit, configured to generate a third indication signal according to a current-limiting voltage and a current sensing voltage related to the output current, wherein the third indication signal is configured to indicate a state of the output current, the current threshold corresponds to α1 times the current-limiting voltage, and α1 is between 0 and 1;
a third indication circuit, configured to generate a fourth indication signal according to a temperature monitoring voltage and the temperature dependent voltage, wherein the fourth indication signal is configured to indicate the junction temperature of the fuse switch, and the temperature threshold corresponds to the temperature monitoring voltage plus a preset voltage difference;
a sub switch control circuit, coupled to the first indication circuit, the second indication circuit and the third indication circuit, and configured to generate a sub switch control signal according to the second indication signal, the third indication signal and the fourth indication signal; and
a sub switch, coupled to the sub switch control circuit and the first sub control node, and configured to be turned on or off according to the sub switch control signal.

13. The fuse circuitry of claim 10, wherein each of the first electronic fuse circuit and the second electronic fuse circuit further comprises:
a soft start circuit, coupled to the main control node, configured to control the output voltage to increase according to a fixed rising slope of a soft start voltage when the output voltage does not reach an operating voltage level, and configured to output an indication signal to the control enable circuit of the current control circuit according to a voltage level of the output voltage, wherein the indication signal is configured to indicate a relationship between the output voltage and the starting voltage level, and the operating voltage level is greater than the starting voltage level;
wherein the control enable circuit is configured to switch the voltage level of the first sub control node to a disable voltage level when the output voltage is lower than the starting voltage level, so as to turn off the first switch.

14. The fuse circuitry of claim 13, wherein the soft start circuit comprises:
a second switch, coupled to the main control node and a second sub control node, configured to generate a second sinking current, and configured to adjust the second sinking current according to a voltage level of the second sub control node, wherein the second sinking current flows out of the main control node, and is configured to adjust the voltage level of the main control node downward;
a second switch control circuit, coupled to the second sub control node, configured to receive the output voltage and the soft start voltage, and configured to adjust the voltage level of the second sub control node according to the output current and the soft start voltage, so that a rising slope of the output voltage, which is lower than the operating voltage level, is the same as the fixed rising slope of the soft start voltage; and
an indication circuit, configured to receive the input voltage and the output voltage, configured to generate the indication signal with the disable voltage level when the output voltage is lower than the starting voltage level, and configured to generate the indication signal with an enable voltage level when the output voltage exceeds the starting voltage level, wherein the starting voltage level is α2 times the operating voltage level, and α2 is between 0 and 1.

15. The fuse circuitry of claim 10, wherein each of the first electronic fuse circuit and the second electronic fuse circuit further comprises:
a current-limiting circuit, coupled to the main control node, configured to control the output current to not exceed a first current limit value when the output voltage is lower than the starting voltage level, and configured to control the output current to not exceed a second current limit value when the output voltage exceeds the starting voltage level, wherein the second current limit value is greater than the first current limit value.

16. The fuse circuitry of claim 15, wherein the current-limiting circuit comprises:
a second switch, coupled to the main control node and a second sub control node, configured to generate a second sinking current, and configured to adjust the second sinking current according to a voltage level of the second sub control node, wherein the second sinking current flows out of the main control node, and is configured to adjust the voltage level of the main control node downward;
a determination circuit, configured to receive a current-limiting voltage, configured to use α3 times the current-limiting voltage as an output when the output voltage is lower than the starting voltage level, and configured to use the current-limiting voltage as the output when the output voltage exceeds the starting voltage level, wherein α3 is between 0 and 1; and
an amplifier circuit, coupled to the second sub control node and the determination circuit, and configured to adjust the voltage level of the second sub control node through a first switch control signal according to a first difference value between a current sensing voltage related to the output current and the output of the determination circuit, so that the output current is the same as one of the first current limit value and the second current limit value, wherein the first current limit value corresponds to α3 times the current-limiting voltage, and the second current limit value corresponds to the current-limiting voltage.

17. The fuse circuitry of claim 10, wherein each of the first electronic fuse circuit and the second electronic fuse circuit further comprises:
a current detection circuit, coupled to the main control node and the fuse switch, and configured to detect the output current to output a first sensing current and a second sensing current, wherein the first sensing current is used to generate the average current voltage, the second sensing current is used to generate a current sensing voltage related to the output current, both a voltage level of the first sensing current and a voltage level of the second sensing current are 1/M times a voltage level of the output current, and M is a positive integer greater than 0.

18. The fuse circuitry of claim 10, wherein each of the first electronic fuse circuit and the second electronic fuse circuit further comprises:
a temperature reporting circuit, disposed near the fuse switch, coupled to the current control circuit, configured to detect the junction temperature of the fuse switch, configured to generate the temperature dependent voltage and a temperature dependent current according to the junction temperature, and configured to provides one of the temperature dependent voltage and the temperature dependent current when the output voltage exceeds the starting voltage level, so as to generate a temperature monitoring voltage, wherein the temperature monitoring voltage is related to the junction temperature of the fuse switch of the first electronic fuse circuit or the second electronic fuse circuit, or is related to an average of the junction temperature of the fuse switch of the first electronic fuse circuit and the junction temperature of the fuse switch of the second electronic fuse circuit.

19. The fuse circuitry of claim 10, wherein the first temperature monitoring pin and the second temperature monitoring pin are coupled at a third node together, and the fuse circuitry further comprises:
a first resistor, coupled to the third node and a ground terminal; and
a second resistor, coupled to the third node and the ground terminal.

20. The fuse circuitry of claim 10, further comprising:
a first resistor, coupled to the first temperature monitoring pin and a power voltage; and
a second resistor, coupled to the second temperature monitoring pin and the power voltage.
